(19) United States
(12) Patent Application Publication
(10) Pub. No.: US 2005/0018884 A1
(43) Pub. Date: Jan. 27, 2005

(54) Fingerprint sensor, fabrication method thereof and fingerprint sensing system

(75) Inventors: Heon Min Lee, Seongnam-si (KR); Don Hee Lee, Anyang-si (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/898,487

(22) Filed: Jul. 22, 2004

(30) Foreign Application Priority Data
Jul. 22, 2003 (KR) 50098/2003
Oct. 2, 2003 (KR) 68831/2003

(51) Int. Cl. G06K 9/00

(52) U.S. Cl. 382/124

(57) ABSTRACT

A fingerprint sensor of the present invention includes a substrate; a plurality of electrode patterns formed on the substrate for detecting an impedance signal in response to the contact of a fingerprint; and an insulating layer formed on the substrate including the electrode patterns.

### CROSS REFERENCE TO RELATED APPLICATIONS

Pursuant to 35 U.S.C. § 119(a), this application claims the benefit of earlier filing date and right of priority to Korean Patent Application Nos. 10-2003-50098 and 10-2003-68831, filed on Jul. 22, 2003 and Oct. 2, 2003, the content of which is hereby incorporated by reference herein in its entirety.

### BACKGROUND OF THE INVENTION

1. Field of the Invention

The present invention relates to fingerprint sensing, and more particularly, to a fingerprint sensor, which enhances fingerprint sensibility and has excellent resistance against corrosion and abrasion, a fabrication method thereof and a fingerprint sensor system incorporating such a fingerprint sensor therein.

2. Description of the Related Art

In general, fingerprint sensors are classified into an AC electric field fingerprint sensor, a DC capacitive fingerprint sensor, a thermal swipe fingerprint sensor and an optical fingerprint sensor according to fingerprint measuring techniques.

The optical sensor is advantageous in the reliability of fingerprint detection but disadvantageous in the relatively large size since it basically uses an optical system.

The AC electric field, DC capacitive and thermal swipe sensors have a common advantage in that a sensor unit, a detection drive unit and a fingerprint detecting algorithm processing unit can be realized on a single chip.

FIG. 1 schematically illustrates an AC electric field fingerprint sensor according to the related art. As shown in FIG. 1, the fingerprint sensor based upon the AC electric field technique has a metal pattern array functioning as an antenna. The metal pattern array generates different AC electric fields according to ridge and furrow of a fingerprint. As a consequence, the fingerprint sensor detects the shape of the fingerprint by measuring the AC electric fields, which are generated different when the fingerprint sensor contacts the ridge and furrow of the fingerprint. In this case, the pattern array may be protected by an insulating layer, which serves to protect the fingerprint sensor from being damaged owing to contact with foreign materials.

Such an AC electric field fingerprint sensor has a technical feature of being relatively resistive against the pollution caused by foreign materials. However, the AC electric field sensor consumes a large quantity of supply voltage since a large quantity of AC voltage is to be applied in order to magnify the variation of electric fields induced from ridge and furrow of a fingerprint. Also, the AC electric field sensor is expensive and complicated since it requires an additional circuit for signal processing for example.

FIG. 2 schematically illustrates a DC capacitive fingerprint sensor. As shown in FIG. 2, the DC capacitive fingerprint sensor is similar to the AC electric field sensor in that it has an array of patterned metal electrodes. However, the DC capacitive fingerprint sensor has a fingerprint detecting technique different from that of the AC electric field fingerprint sensor. That is, when a fingerprint contacts the surface of the DC capacitive fingerprint sensor, capacitance is changed differently as different regions such as ridge and furrow of the fingerprint contact the sensor. When a furrow of the fingerprint contacts the sensor, the capacitance is changed due to air having a dielectric constant e₀. When a ridge of the fingerprint contacts the sensor, the capacitance is changed due to the human skin having a dielectric constant e. As a result, this sensor detects the shape of a fingerprint based upon the capacitance change different according to ridge and furrow of the fingerprint. In this case, the capacitance changes according to the ridge and furrow of the fingerprint range from a few tens pF to a few hundreds pF. The DC capacitive fingerprint sensor may adopt various types of drive circuits for analyzing the capacitance change.

However, the DC capacitance fingerprint sensor may be polluted when contacted by a hand, and such pollution may cause an after-image to the sensor. Accordingly, it is necessary to periodically clean the surface of the DC capacitance fingerprint sensor. Also, the DC capacitive fingerprint sensor is disadvantageously vulnerable to Electro Static Discharge (ESD). Furthermore, this sensor hardly distinguishes a human fingerprint from a forged one.

FIG. 3 schematically illustrates a thermal swipe fingerprint sensor. As shown in FIG. 3, the thermal swipe fingerprint sensor includes unit sensors which are arranged in a linear array. A hand generally dissipates heat, and the thermal swipe fingerprint sensor detects fingerprints based upon such heat. More particularly, when a unit sensor contacts a hand, ridge and furrow of a fingerprint dissipate different quantities of heat. So, the sensor detects the shape of the fingerprint based upon the different quantities of heat. Herein the unit sensor may be made of pyroelectric material.

However, the thermal swipe fingerprint sensor has a drawback in that it reacts sensitively to the ambient temperature. Also, it is difficult to obtain fine fingerprint images until being accustomed to an operation of swipe.

As described hereinbefore, various conventional fingerprint sensors hardly have excellent fingerprint sensibility, and are vulnerable to foreign materials.

### SUMMARY OF THE INVENTION

Accordingly, the present invention is directed to a fingerprint sensor, a fabrication method thereof and a fingerprint sensor system that substantially obviate one or more problems due to limitations and disadvantages of the related art.

An object of the present invention is to provide a fingerprint sensor, a fabrication method thereof and a fingerprint sensor system, in which an impedance difference between a ridge and a furrow of a fingerprint is increased to improve fingerprint sensibility.

Another object of the present invention is to provide a fingerprint sensor, a fabrication method thereof and a fingerprint sensor system, in which both corrosion resistance and abrasion resistance are enhanced by using ceramic-based materials.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a fingerprint sensor including: a substrate; a plurality of electrode patterns formed on the substrate, for detecting an impedance signal in response to the contact of a fingerprint; and an insulating layer formed on the substrate including the electrode patterns.

Preferably, the electrode patterns are made of one selected from the group consisting of Poly-Si, Al, Cr, Ta, Ti, Pt, Ir, Au and Mo.

Preferably, the insulating layer is planarized such that the electrode patterns are exposed to the outside when the electrode patterns are made of a material resistive against foreign materials. Also, the material resistive against foreign materials may be one selected from the group consisting of Pt, Mo and Ir.

The fingerprint sensor may further comprise passivation conductor patterns formed on the exposed electrode patterns, respectively. Preferably, the passivation conductor patterns are made of one selected from the group consisting of Indium Tin Oxide (ITO), RuO₂ and IrO₂.

According to another aspect of the present invention, there is provided a fingerprint sensor system including: a sensor array including a plurality of unit sensors arranged into a matrix configuration, each of the unit sensors having electrode patterns for detecting fingerprints; and a drive unit for outputting an output signal in response to an impedance signal detected by a corresponding one of the electrode patterns.

Preferably, the electrode patterns are one selected from the group consisting of open comb, closed comb and specifically patterned electrodes.

Preferably, the drive unit determines the electrode signal based upon voltage division.

According to a further aspect of the present invention, there is provided a method for fabricating a fingerprint sensor, the method comprising the steps of: depositing electrode material on a substrate; forming a plurality of electrode patterns using the electrode material; and depositing an insulating layer on the substrate including the electrode patterns.

The fingerprint sensor may further comprise the step of planarizing the insulating layer such that the electrode patterns are exposed to the outside if the electrode patterns are made of a material resistive against foreign materials.

According to still another aspect of the invention for realizing the above objects, there is provided a method for fabricating a fingerprint sensor, the method including the steps of: sequentially depositing first and second materials on a substrate; forming a plurality of electrode patterns and passivation conductor patterns using the first and second materials; forming an insulating layer on the substrate including the electrode patterns and the passivation conductor patterns; and planarizing the insulating layer such that the passivation conductor patterns are exposed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 schematically illustrates an AC electric field fingerprint sensor;

FIG. 2 schematically illustrates a DC capacitive fingerprint sensor;

FIG. 3 schematically illustrates a thermal swipe fingerprint sensor;

FIG. 4 schematically illustrates the structure of a fingerprint sensor according to a preferred embodiment of the invention;

FIGS. 5A through 5C illustrate various electrode patterns formed in a unit sensor shown in FIG. 2;

FIG. 6 illustrates an equivalent circuit of the unit sensor shown in FIG. 4;

FIG. 7 illustrates the equivalent circuit of the unit sensor shown in FIG. 4 in contact with a peak of a fingerprint;

FIG. 8 illustrates a fingerprint sensor according to a first embodiment of the present invention shown in FIG. 4;

FIG. 9 illustrates a fingerprint sensor according to a second embodiment of the present invention shown in FIG. 4;

FIGS. 10A through 10D illustrate a fabrication method of fingerprint sensors according to a preferred embodiment of the present invention;

FIG. 11 is a sectional view schematically illustrating the structure of a fingerprint sensor according to a second preferred embodiment of the present invention; and

FIGS. 12A through 12E are sectional views illustrating a fabrication method of fingerprint sensors according to the second preferred embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

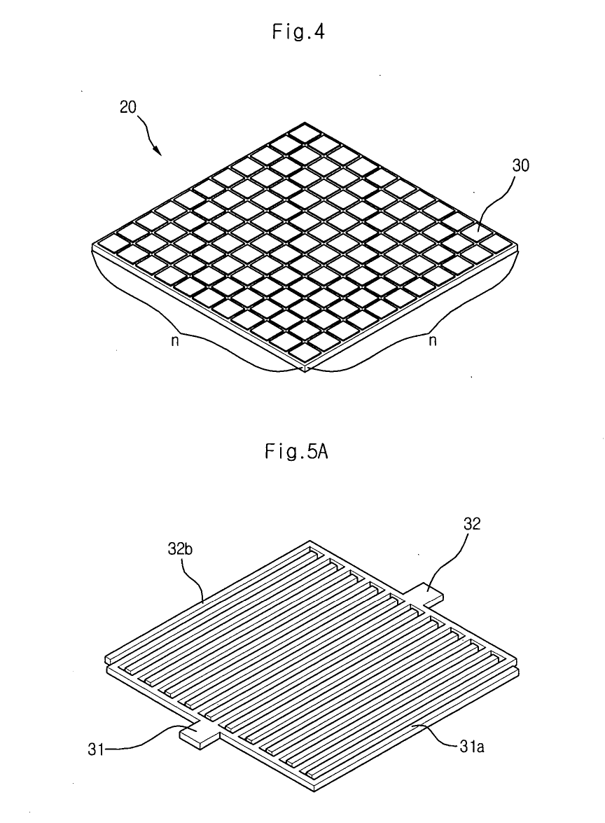

FIG. 4 schematically illustrates the structure of a fingerprint sensor according to a preferred embodiment of the invention. As shown in FIG. 4, the fingerprint sensor of the invention includes a number of unit sensors 30 arranged in an n×n array or matrix, in which a sensor array 20 having electrode patterns for sensing fingerprint is provided in each unit sensor 30.

A fingerprint sensor system may include the sensor array and a drive unit for outputting a signal in response to an impedance signal detected by the electrode patterns.

A unit sensor is typically sized in the order of 50×50 μm² to realize a resolution of at least 500 dpi.

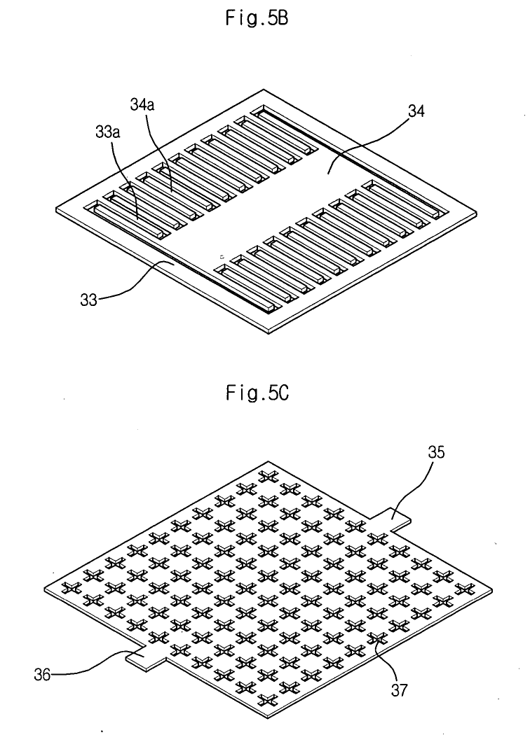

FIGS. 5A through 5C illustrate various electrode patterns formed in a unit sensor shown in FIG. 2. As shown in FIGS. 5A to 5C, the unit sensor 30 may be provided with electrode patterns for example in the form of open comb type, closed comb type and specifically patterned electrode patterns.

As shown in FIG. 5A, open comb type electrode patterns include first and second ports 31 and 32 opposed to each other, in which each of the first and second ports 31 and 32 has a number of fingers 31a or 32a. That is, the fingers 31a of the first port 31 are opposed to and alternate with the fingers 32a of the second port 32. The fingers 31a of the first port 31 are also uniformly spaced from the fingers 32a of the second port 32, respectively. Preferably, both of the fingers 31a of the first port 31 and the fingers 32a of the second port 32 have the same length.

As shown in FIG. 5B, closed comb type electrode patterns include a first port 33 having a number of fingers 33a oriented inward and a second port 34 having a number of fingers 34a oriented outward. The fingers 33a of the first port 33 are extended inward from both sides of the first port 33, and the fingers 34a of the second port 34 are extended outward from both sides of the second port 34. The fingers 33a of the first port 33 are opposed to and alternate with the fingers 34a of the second port 34. The fingers 33a of the first port 33 are uniformly spaced from the fingers 34a of the second port 34, respectively. Preferably, both of the fingers 33a of the first port 33 and the fingers 34a of the second port 34 have the same length.

As shown in FIG. 5C, specifically patterned electrode patterns have first and second ports 35 and 36 at both sides of a sensor, a wide planar pad extended between the first and second ports 35 and 36 and a specifically patterned configuration 37 formed on the pad for example via etching. The patterned configuration 37 may have various forms such as a cross, circle, polygon and line.

Though not shown in FIG. 4, the sensor array 20 may be provided at the bottom with a read-out wiring for reading impedance signals detected by the individual unit sensors 30. Upon the transmission of the impedance signals via the read-out wiring, the drive unit detects the variation of the impedance signals.

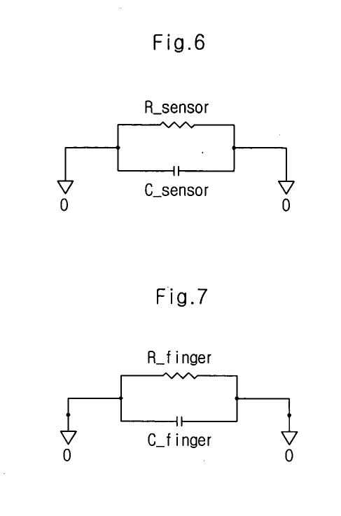

FIG. 6 illustrates an equivalent circuit of the unit sensor shown in FIG. 4, and FIG. 7 illustrates an equivalent circuit of the unit sensor shown in FIG. 4 in contact with a ridge of a fingerprint.

As shown in FIG. 6, the unit sensor includes a resistance represented by the reference R_sensor and a capacitance represented by the reference C_sensor, connected in parallel with the resistance. The impedance is determined by the resistance R_sensor and the capacitance C_sensor.

Contacting a ridge of the fingerprint with the unit sensor causes variation in the resistance and capacitance as represented by the references R_finger and C_finger to change the impedance as shown in FIG. 7. When a furrow of the fingerprint contacts the unit sensor, there are no variations in the resistance R_sensor and the capacitance C_sensor as shown in FIG. 6 thereby causing no change in the impedance. As a result, the fingerprint is detected based upon the different impedances induced from the ridge and the furrow of the fingerprint in contact with the sensor.

In detection of the fingerprint based upon the above mechanism, the variation of impedance becomes an important variable in the determination of sensibility to the fingerprint. Therefore, the present invention forms the electrode patterns in the unit sensor into open comb type, closed comb type and specifically patterned electrode patterns to maximize the impedance change according to the ridge and furrow of the fingerprint thereby improving fingerprint sensibility.

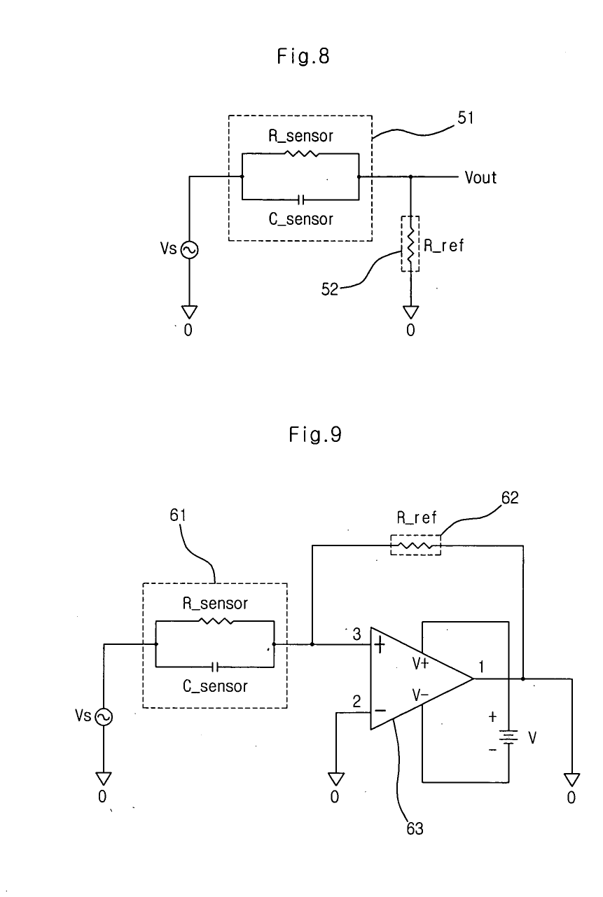

FIG. 8 illustrates a fingerprint sensor according to a first embodiment of the present invention shown in FIG. 4. As described above (refer to FIG. 5A), each unit sensor 30 has first and second ports 31 and 32 so that a supply voltage Vs is supplied via the first port 31. An impedance 51 including a resistance R_finger and a capacitance C_finger connected in parallel is connected between the first and second ports 31 and 32, and a reference impedance 52 is connected to the second port 32. As a result, the impedance 51 and the reference impedance 52 in the unit sensor 30 are connected in series with each other. This enables an output signal Vout at the reference impedance 52 to be measured based upon the voltage division by the impedance 51 and the reference impedance 52. The impedance 51 is changed differently whether the unit sensor 30 contacts the ridge of the fingerprint or the furrow of the fingerprint. That is, the impedance 51 is not changed at the contact with the furrow of the fingerprint, but changed significantly at the contact with the ridge of the fingerprint. This means that the output signal Vout is determined by the impedance 51. As a result, it is possible to detect the configuration of a fingerprint by measuring individual output signals Vout from individual unit sensors 30 in response to the contact with ridge and furrow of the fingerprint.

In this case, the reference impedance 52 serves to generate the output signal Vout, and may be provided in the form of a unit sensor that is not in contact with the fingerprint.

Where the supply voltage Vs is a DC voltage, only the resistance R_finger of the impedance 51 may be considered. On the other hand, at an AC supply voltage Vs, the impedance may be considered based upon not only the resistance R_finger but also the capacitance C_finger.

FIG. 9 illustrates a fingerprint sensor according to a second embodiment of the present invention shown in FIG. 4. The structure shown in FIG. 9 is basically similar to that in FIG. 8. That is, an impedance 61 of each unit sensor in FIG. 9 is equal to the impedance 51 in FIG. 8, but a reference impedance of FIG. 9 is different from the reference impedance 52 of FIG. 8. As shown in FIG. 9, in addition to the impedance 61 and the reference impedance 62, an amplifier 63 is connected to the impedance 62. The amplifier 63 serves to amplify an output signal produced through the voltage division to enhance the impedance change in order to improve the fingerprint sensibility. In this case, the reference impedance 62 serves to generate the output signal, and may be provided in the form of a unit sensor that is not in contact with the fingerprint.

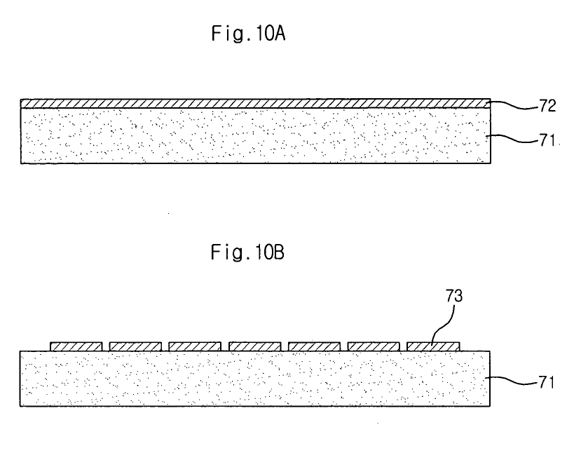

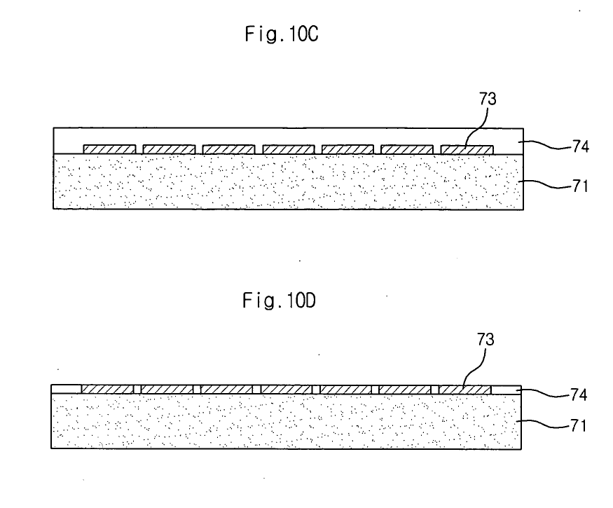

FIGS. 10A through 10D illustrate a fabrication method of fingerprint sensors according to a preferred embodiment of the present invention.

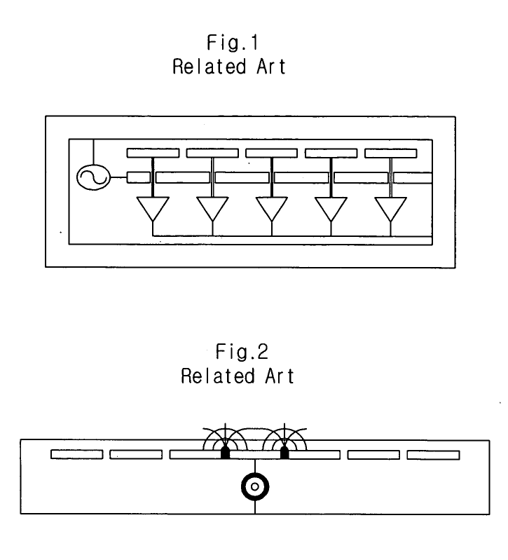

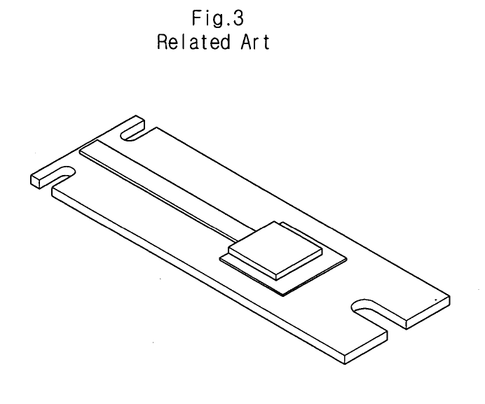

As shown in FIG. 1A, an electrode material 72 is deposited on a substrate 71. Herein a drive unit and optionally a system IC may be provided in the substrate 71. As all elements of a fingerprint sensor are provided in a single substrate, there is an advantage in that the fingerprint sensor can be reduced in size and thickness. Alternatively, only the fingerprint sensor is provided in the substrate 71, and the drive unit and the system IC may be realized in a PCB via off-chip technology. The electrode material 72 may be selected from the group consisting of poly-Si, Al, Cr, Ta, Ti, Pt, Ir, Au and Mo. In case that the fingerprint directly contacts the electrode material 72, the contact material 72 may be selected from the group consisting of Pt, Mo and Ir which are resistive against foreign materials.

As shown in FIG. 10B, the electrode material 72 deposited on the substrate 71 is formed into predetermined electrode patterns 73. The electrode patterns 73 indicate electrode patterns shown in FIGS. 5A to 5C. As described above, the electrode patterns may have a plurality of fingers connected to the first and second ports or a plurality of fingers formed on the pad placed between the first and second ports. The electrode patterns may be formed based upon dry etching, wet etching or lift-off process.

As shown in FIG. 10C, an insulating layer 74 is deposited on the substrate having the electrode patterns 73 in order to insulate the electrode patterns from adjacent ones as well as protect the electrode patterns from foreign materials. Herein the insulating layer 84 may be made of one selected from the group consisting of oxide, SiO₂ and SiNx.

According to the fabrication method of fingerprint sensors as above, it is possible to improve fingerprint sensibility based upon electrode patterns showing a significant impedance change as well as protect a fingerprint sensor from foreign materials thereby improving the reliability of the fingerprint sensor.

In case that the electrode patterns 73 are made of a material resistive against foreign materials such as Pt, Mo and Ir, the deposited insulating layer 74 is planarized such that the electrode patterns 73 are exposed to the outside as shown in FIG. 10D. As a consequence, since the electrode patterns 73 are made of the material resistive against foreign materials, they are not polluted by the foreign materials even though exposed to the outside. Also, it is possible to reduce the size and thickness of the fingerprint sensor.

Since the electrode patterns are formed applicable to both AC and DC voltages, the fingerprint sensor fabricated as above can be applied to various power sources.

The first embodiment of the present invention can improve the fingerprint sensibility since it adopts the electrode patterns having a significant impedance change. Also, the size and thickness of the fingerprint sensor can be reduced by forming the electrode patterns from the electrode material resistive against foreign materials. There is also an advantage in that the first embodiment of the present invention can be widely applied since it can be used in both of AC and DC voltages.

As a result, by reading the variation of resistance in the unit fingerprint sensor in response to the contact or non-contact of the electrode patterns 73 with a fingerprint, the shape of the fingerprint can be detected.

Also, in the fingerprint sensor according to the first embodiment of the present invention, the electrode patterns frequently contact fingerprints. Then, the electrode patterns are apt to corrode or abrade resulting from repeated frequent contact with fingerprints even though they are made of a metal material resistive against foreign materials. In particular, Na component existing in the human skin by a large quantity may promote the corrosion and abrasion of the electrode patterns. The corroded or abraded electrode patterns may worsen the reliability of the fingerprint sensor.

Hereinafter a fingerprint sensor capable of overcoming such problems will be described.

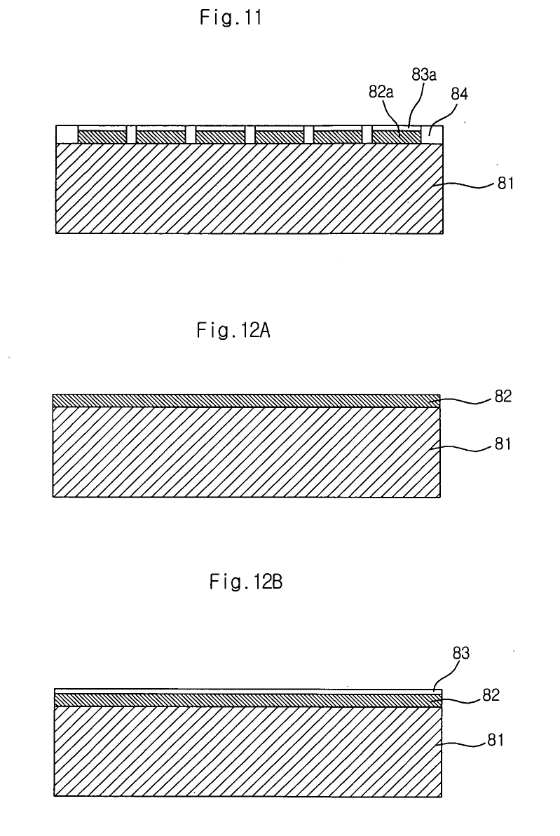

FIG. 11 is a sectional view schematically illustrating the structure of a fingerprint sensor according to a second preferred embodiment of the present invention.

The fingerprint sensor shown in FIG. 11 has a structure shown in FIG. 4. More particularly, the fingerprint sensor according to the second embodiment of the present invention includes a sensor array 20 having a plurality of unit sensors 30 arranged in an n×n array or matrix, in which each of the unit sensors 30 has electrode patterns for detecting fingerprints. A drive unit for outputting an output signal in response to an impedance signal detected by the sensor array and the electrode patterns may be further provided to constitute a fingerprint sensor system. In order to maintain a resolution of about at least 500 dpi, the unit sensor is sized of about 50×50 μm².

The electrode patterns formed in the unit sensor 30 may be provided in the form of open comb, closed comb, or specifically patterned electrode type electrode patterns. The electrode types will be described further since they were explained previously.

As shown in FIG. 11, the fingerprint sensor according to the second embodiment of the present invention includes a substrate 81, a plurality of electrode patterns 82a formed on the substrate 81, in which each of the electrode patterns 82a has first and second ports, a plurality of passivation conductor patterns 83a formed on the electrode patterns 82a, respectively, and an insulating layer 84 formed on areas of the substrate 81 which are not occupied by the electrode patterns 82a and the passivation conductor patterns 83a.

Herein the electrode patterns 82a may be made of one selected from the group consisting of poly-Si, Al, Cr, Ta, Ti, Pt, Ir, Au and Mo. The passivation conductor patterns 83a may be made of one selected from the group consisting of Indium Tin Oxide (ITO), RuO₂ and IrO₂. Furthermore, the insulating layer 84 may be made of one selected from the group consisting of oxide, SiO₂ and SiNx.

Owing to the passivation conductor patterns 83a for protecting the electrode patterns 82a, the fingerprint sensor as above can permanently and safely protect the electrode patterns 82a in order to improve both of corrosion resistance and abrasion resistance. In this case, as described hereinbefore, the passivation conductor patterns 83a may be made of a conductive material such as ITO, RuO₂ and IrO₂ in order not to influence the sensibility of the electrode patterns 82a.

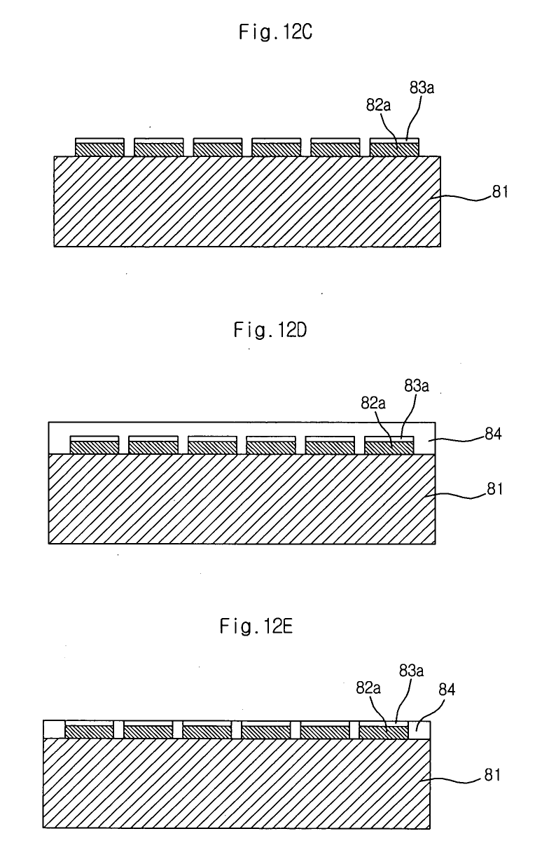

FIGS. 12A through 12E are sectional views illustrating a fabrication method of fingerprint sensors according to the second preferred embodiment of the present invention.

As shown in FIG. 12A, first material 82 is deposited on a substrate 81. Herein a drive unit IC and optionally a system IC may be provided in the substrate 81. Because all elements of a fingerprint sensor are provided in a single substrate like this, there is an advantage in that a fabricated fingerprint sensor can be reduced with size and thickness. Alternatively, only the fingerprint sensor may be provided in the substrate 81, and other elements such as the drive unit or the system IC may be realized on a PCB. The second material 82 may be selected from the group consisting of poly-Si, Al, Cr, Ta, Ti, Pt, Ir, Au and Mo.

Next, as shown in FIG. 12B, second material 83 is deposited on the deposited first material 82. Herein the second material may be of ceramic-based material such as ITO, RuO₂ and IrO₂.

Then, as shown in FIG. 12C, the first material 82 is formed into a plurality of electrode patterns 82a and the second material 83 is formed into a plurality of passivation conductor patterns 83a. The passivation conductor patterns 83a may be made of one selected from the group consisting of ITO, RuO₂ and IrO₂. The electrode patterns 82a and the passivation conductor patterns 83a may be obtained by using dry etching, wet etching or lift-off process. Herein the electrode patterns 82a and the passivation conductor patterns 83a are formed through the same process. The passivation conductor patterns 83a can permanently protect the electrode patterns 82a against foreign materials in order to improve the corrosion resistance and the abrasion resistance of the electrode patterns 82a.

As shown in FIG. 12D, an insulating layer 84 is formed on the substrate 81 including the electrode and passivation conductor patterns 82a and 83a. Herein the insulating layer 84 may be made of one selected from the group consisting of ITO, SiO₂ and SiNx.

The insulating layer 84 serves to maintain the electrode patterns 82a in an insulated state from adjacent ones while protecting sides of the electrode patterns 82a from foreign materials. Herein the insulating layer 84 may be made of one selected from the group including oxide, SiO₂ and SiNx.

Then, as shown in FIG. 12E, the insulating layer 84 is planarized the passivation conductor patterns 83a are exposed. By planarizing the insulating layer 84, a resultant fingerprint sensor can be reduced with size and thickness.

The second embodiment of the present invention provides individual passivation conductor patterns 83a on individual electrode patterns 82a to protect the electrode patterns 82a from being directly exposed to hostile fingerprint detection environments. This also allows a DC resistive fingerprint sensor to achieve a predetermined level of fingerprint sensibility regardless of electrical deterioration characteristics thereof. Therefore, the fingerprint sensor according to the second embodiment of the present invention can be used stably and permanently in certain fingerprint environments where the human skin containing Na component directly contacts the fingerprint sensor, and achieve more excellent fingerprint sensibility.

As described above, the present invention forms the electrode patterns showing significant impedance change in order to improve the fingerprint sensibility of the fingerprint sensor while reducing the size and thickness of the fingerprint sensor. Also, the fingerprint sensor can be operated in DC and AC voltages.

Further, the present invention protects the electrode patterns with the passivation conductor patterns to improve the corrosion resistance and the abrasion resistance of the fingerprint sensor thereby realizing high reliability products.

It will be apparent to those skilled in the art that various modifications and variations can be made in the present invention. Thus, it is intended that the present invention covers the modifications and variations of this invention provided they come within the scope of the appended claims and their equivalents.

1. A fingerprint sensor comprising:
a substrate;
a plurality of electrode patterns formed on the substrate, for detecting an impedance signal in response to the contact of a fingerprint; and
an insulating layer formed on the substrate including the electrode patterns.

2. The fingerprint sensor according to claim 1, wherein the electrode patterns are made of one selected from the group consisting of Poly-Si, Al, Cr, Ta, Ti, Pt, Ir, Au and Mo.

3. The fingerprint sensor according to claim 1, wherein the insulating layer is planarized such that the electrode patterns are exposed to the outside when the electrode patterns are made of a material resistive against foreign materials.

4. The fingerprint sensor according to claim 3, wherein the material resistive against foreign materials is one selected from the group consisting of Pt, Mo and Ir.

5. The fingerprint sensor according to claim 3, further comprising passivation conductor patterns formed on the exposed electrode patterns.

6. The fingerprint sensor according to claim 5, wherein the passivation conductor patterns are made of one selected from the group consisting of ITO (Indium Tin Oxide), RuO₂ and IrO₂.

7. The fingerprint sensor according to claim 1, wherein the insulating layer is made of one selected from the group consisting of oxide, SiO₂ and SiNx.

8. A fingerprint sensor system comprising:
a sensor array including a plurality of unit sensors arranged into a matrix configuration, each of the unit sensors having electrode patterns for detecting fingerprints; and
a drive unit for outputting an output signal in response to an impedance signal detected by a corresponding one of the electrode patterns.

9. The fingerprint sensor system according to claim 8, wherein each of the unit sensors has a size of about 50×50 μm².

10. The fingerprint sensor system according to claim 8, wherein the electrode patterns are one selected from the group consisting of open comb, closed comb and specifically patterned electrodes.

11. The fingerprint sensor system according to claim 8, wherein the drive unit determines the electrode signal based upon voltage division.

12. A method for fabricating a fingerprint sensor, the method comprising the steps of:
depositing electrode material on a substrate;
forming a plurality of electrode patterns using the electrode material; and
depositing an insulating layer on the substrate including the electrode patterns.

13. The method according to claim 12, further comprising the step of planarizing the insulating layer such that the electrode patterns is exposed to the outside if the electrode patterns are made of a material resistive against foreign materials.

14. The method according to claim 13, wherein the material resistive against foreign materials is one selected from the group consisting of Pt, Mo and Ir.

15. The method according to claim 12, wherein the electrode patterns are made of one selected from the group consisting of poly-Si, Al, Cr, Ta, Ti, Pt, Ir, Au and Mo.

16. The method according to claim 12, wherein the insulating layer is made of one selected from the group consisting of oxide, SiO₂ and SiNx.

17. A method for fabricating a fingerprint sensor, the method comprising the steps of:
sequentially depositing first and second materials on a substrate;
forming a plurality of electrode patterns and passivation conductor patterns using the first and second materials;
forming an insulating layer on the substrate including the electrode patterns and the passivation conductor patterns; and
planarizing the insulating layer such that the passivation conductor patterns are exposed.

18. The method according to claim 17, wherein the first material is one selected from the group consisting of poly-Si, Al, Cr, Ta, Ti, Pt, Ir, Au and Mo.

19. The method according to claim 17, wherein the insulating layer is made of one selected from the group consisting of oxide, SiO₂ and SiNx.

20. The method according to claim 17, wherein the second material is one selected from the group consisting of Indium Tin Oxide (ITO), RuO₂ and IrO₂.
